(19) United States
(12) Patent Application Publication
(10) Pub. No.: US 2014/0181116 A1
(43) Pub. Date: Jun. 26, 2014

(54) Method and device of cloud storage

(71) Applicant: TIANJIN SURSEN INVESTMENT CO., LTD., TIANJIN (CN)

(72) Inventor: Donglin Wang, Tianjin (CN)

(73) Assignee: TIANJIN SURSEN INVESTMENT CO., LTD., TIANJIN (CN)

(21) Appl. No.: 13/858,489

(22) Filed: Apr. 8, 2013

Related U.S. Application Data
(63) Continuation-in-part of application No. 13/271,165, filed on Oct. 11, 2011.
(60) Provisional application No. 61/621,553, filed on Apr. 8, 2012.

(30) Foreign Application Priority Data
May 2, 2012 (CN) 201210132926.7
May 12, 2012 (CN) PCT/CN2012/075841
May 16, 2012 (CN) 201210151984.4
May 16, 2012 (CN) PCT/CN2012/076516

(51) Int. Cl. G06F 17/30

(52) U.S. Cl. CPC G06F 17/30321
USPC 707/741

(57) ABSTRACT

Embodiments of the present invention disclose a cloud storage method and device, to provide efficient storage of huge amounts of data. The cloud storage method includes: calculating the hash value of a file, converting the hash value of the file into the string, and using the string as the filename; calculating the storage path of the file by using the hash value of the file according to a predefined rule; looking up a physical storage location of the storage path of the file in an index table and storing the file in the physical storage location, wherein the index table stores corresponding relationship tables between all possible storage paths and physical locations in the storage disk in advance.

### CROSS-REFERENCE TO RELATED APPLICATION

The application is a continuation of PCT/CN2012/075841 (filed on May 22, 2012), which claims priority of Chinese patent application 201210132926.7 (filed on May 2, 2012), the contents of which are incorporated herein by reference.

The application is also a continuation of PCT/CN2012/076516 (filed on Jun. 6, 2012), which claims priority of Chinese patent application 201210151984.4 (filed on May 16, 2012), the contents of which are incorporated herein by reference.

The application claims priority to U.S. Provisional Patent Application No. 61,621,553 (filed on Apr. 8, 2012), the contents of which are incorporated herein by reference.

The application a continuation-in-part of U.S. patent application Ser. No. 13/271,165 (filed on Oct. 11, 2011), the contents of which are incorporated herein by reference.

### FIELD OF THE INVENTION

The embodiments of the present invention are related to the Internet field, especially related to method and device of cloud storage.

### BACKGROUND OF THE INVENTION

The concept of cloud storage immediately attracted the support and attention of numerous manufacturers after it is proposed. The essence of cloud storage is to store mass data in the cloud, which is accessed by the client through the Internet. However, how to store the mass cloud data in the cloud is an essential question of cloud storage.

In the prior art, the method for many cloud storage providers storing huge data in the cloud is: assigning relatively independent spaces to different users respectively, and the users' data are stored in corresponding spaces respectively. When the data is large enough, there will be a lot of duplicate data in the cloud. The current storage method will cause duplicate storage of many data, and is very inefficient.

There are various kinds of big data storage systems in existing technologies. FIG. 1 shows a commonly used big data storage system in existing technologies. As shown in FIG. 1, the big data storage system in existing technologies usually uses the method of SAN and fiber switch, which makes it very expensive. The cloud storage technology represented by Hadoop uses a large number of cheap servers to form mass storage capacity, which considerably reduces the cost compared with SAN. However, with this technology, each storage device still needs to be equipped with the corresponding storage server. This technology also has a high requirement of network bandwidth and expensive network devices. Furthermore, there is still a risk of the single point of failure in Name Node. The cost, performance, and reliability are still not ideal.

Therefore, big data storage architecture with high performance and low cost is needed.

### BRIEF DESCRIPTION OF THE DRAWINGS

FIG. 1 illustrates the structure diagram of a commonly used big data storage system in prior art.

FIG. 2 illustrates the structure diagram of a big data storage system in an embodiment of the present invention.

FIG. 3 illustrates the structure diagram of a big data storage system in an embodiment of the present invention.

FIG. 4 illustrates the structure diagram of a big data storage system in another embodiment of the present invention.

FIG. 5 illustrates the structure diagram of a big data storage system in another embodiment of the present invention.

FIG. 6 illustrates the flowchart of a cloud storage method in an embodiment of the present invention.

FIG. 7 illustrates the structure diagram of a cloud storage device in an embodiment of the present invention.

FIG. 8 illustrates the structure diagram of a cloud document service in an embodiment of the present invention.

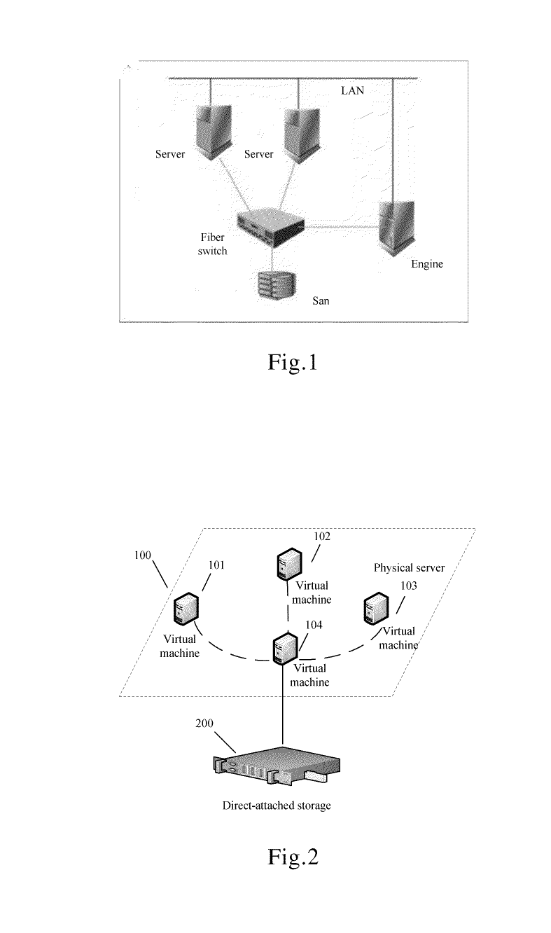

### DETAILED DESCRIPTION OF THE INVENTION

The embodiments of the present invention are described in more detail hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as systems, methods or devices. The following detailed description should not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.” The term “coupled” implies that the elements may be directly connected together or may be coupled through one or more intervening elements. Further reference may be made to an embodiment where a component is implemented and multiple like or identical components are implemented.

While the embodiments make reference to certain events this is not intended to be a limitation of the embodiments of the present invention and such is equally applicable to any event where goods or services are offered to a consumer.

Further, the order of the steps in the present embodiment is exemplary and is not intended to be a limitation on the embodiments of the present invention. It is contemplated that the present invention includes the process being practiced in other orders and/or with intermediary steps and/or processes.

The present invention is further described in detail hereinafter with reference to the accompanying drawings as well as embodiments so as to make the objective, technical scheme and merits thereof more apparent.

Embodiments of the present invention discloses a big data storage system to provide big data storage architecture with high performance, low cost, and high reliability.

A big data storage system, disclosed in embodiments of the present invention, includes multiple virtual machines running on a first physical server and a first storage disk, wherein the first physical server is directly connected with the first storage disk; wherein,

the first storage disk is adapted to provide data storage;

one of the multiple virtual machines is adapted to support shared storage function;

others of the multiple virtual machines, connected with the virtual machine supporting shared storage function through the internal bus, are adapted to receive the user request, get data on the first storage disk through the virtual machine supporting shared storage function according to a user request, and present data on the first storage disk to the user.

In one embodiment of the present invention, the multiple virtual machines running on the first physical server are divided into at least two service groups, each service group gets data on the first storage disk through the virtual machine supporting shared storage function.

In one embodiment of the present invention, when the first physical server and the first storage disk form a subsystem, the system further includes:

at least one subsystem, adapted to process and store data from different users;

a front server, adapted to receive the user request, guide the user request to the corresponding subsystem for processing and store the user request according to the corresponding relationship between each user and the subsystem.

In one embodiment of the present invention, the system further includes:

an index database, adapted to store the corresponding relationship between the user ID and the subsystem, for the front server to invoke.

In one embodiment of the present invention, the at least one subsystem

includes multiple virtual machines running on a second physical server and a second storage disk;

the first physical server and the second physical server are directly connected with the first storage disk and the second storage disk, respectively;

the multiple virtual machines running on the second physical server are adapted to access the data on the first storage disk when the first physical server stops working. The multiple virtual machines running on the second physical server that access the data on the first storage disk are original service groups or newly-built service groups on the second physical server.

In one embodiment of the present invention, the first storage disk is further adapted to store the mirror image of the multiple virtual machines running on the first physical server;

the second physical server is further adapted to invoke the mirror image of the multiple virtual machines running on the first physical server in the first storage disk, and access data on the first storage disk through the mirror image of multiple virtual machines running on the first physical server, when the first physical server stops working.

In one embodiment of the present invention, the system further includes:

a monitoring server, adapted to monitor thstatus of the first physical server and the second physical server.

In one embodiment of the present invention, the system further includes:

a NAS, adapted to back up the data on the first storage disk, and directly provide the data to the multiple virtual machines when the first storage disk is damaged.

In one embodiment of the present invention, the direct-attached storage includes one disk array or a set of cascaded disk arrays.

Using the big data storage system provided in embodiments of the present invention, the direct-attached storage disk is directly connected with the physical server, which ensures high access efficiency compared with the network connection. With multiple virtual machines running on one physical server, the physical server can be used to replace the function of multiple physical servers in existing technologies, which guarantees flexible architecture and low cost. Furthermore, since multiple virtual machines are connected with each other through the internal bus, which guarantees a high access speed. Hence, data storage system provided in embodiments of the present invention has the advantages of high performance and low cost.

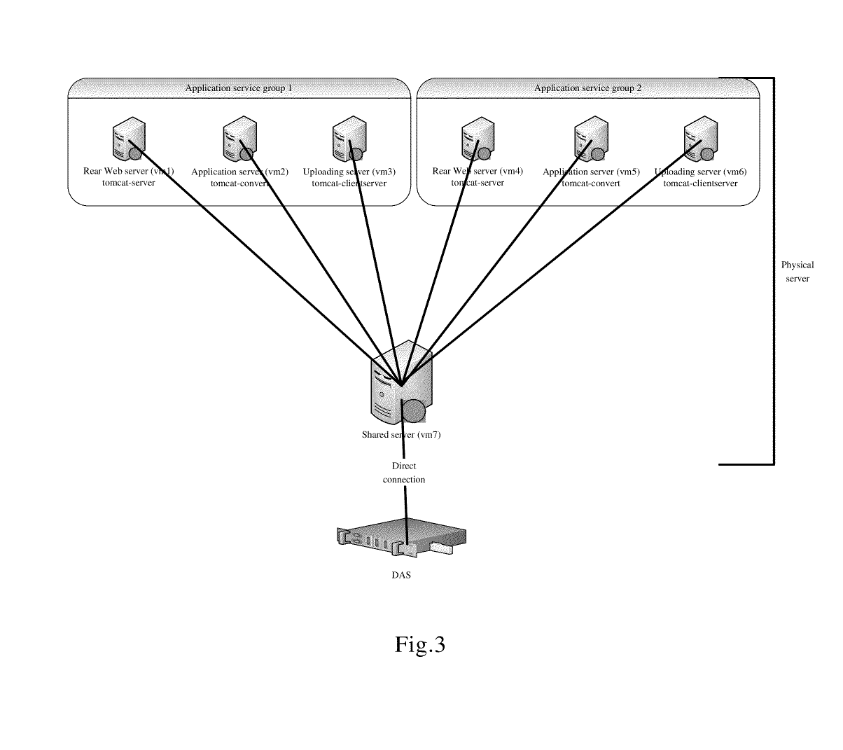

FIG. 2 illustrates the structure diagram of the big data storage system provided in embodiments of the present invention. As shown in FIG. 2, the physical server 100 is directly connected with direct-attached storage 200. Multiple virtual machines 101-104 are running on physical server 100, wherein virtual machine 104 supports the shared storage function. Virtual machines 101-103 are directly connected with virtual machine 104 through the internal bus.

Virtual machines 101-103 are adapted to receive the user request, and get data on a direct-attached storage 200 through a virtual machine 104 according to the user request, and represent data on the direct-attached storage 200 to the user.

The direct-attached storage 200 is adapted to provide data storage.

The skilled in the art can understand that the number of virtual machines on the physical server shown in FIG. 2 is not used to limit the scope of the present invention. The type of virtual machines can be changed and the number of virtual machines can be increased or decreased according to the performance of physical servers and the requirement of actual applications. Presenting data to the user is only one of applications of the present inventions. The scheme of embodiments of the present invention also includes other applications of data processing.

In one embodiment of the present invention, each direct-attached storage can be composed by a disk array. In one embodiment of the present invention, the RAID method may be adopted on disk array to improve the reliability. The storage capacity can be increased by increasing the number of disks in the disk array. In one embodiment of the present invention, the direct-attached storage 200 may be also composed by multiple cascaded disk arrays with methods including SAS-to-SAS.

Multiple virtual machines in embodiments of the present invention correspond to the server cluster in existing technologies. The extensible DAS in embodiments of the present invention corresponds to SAN in existing technologies. The technical scheme provided in embodiments of the present invention does not need storage servers and the expensive optical fiber network system required in existing technologies, which considerably reduces the cost. Furthermore, in existing technologies, when reading data, firstly read data into the storage server, then pass data through the network switch, and finally transmit data to the application server. However, in the technical scheme provided in embodiments of the present invention, when reading data, directly read data into the shared virtual machine, and then transmit the data to the application virtual machine through the internal bus. Hence, the technical scheme provided in embodiments of the present invention has better data access efficiency.

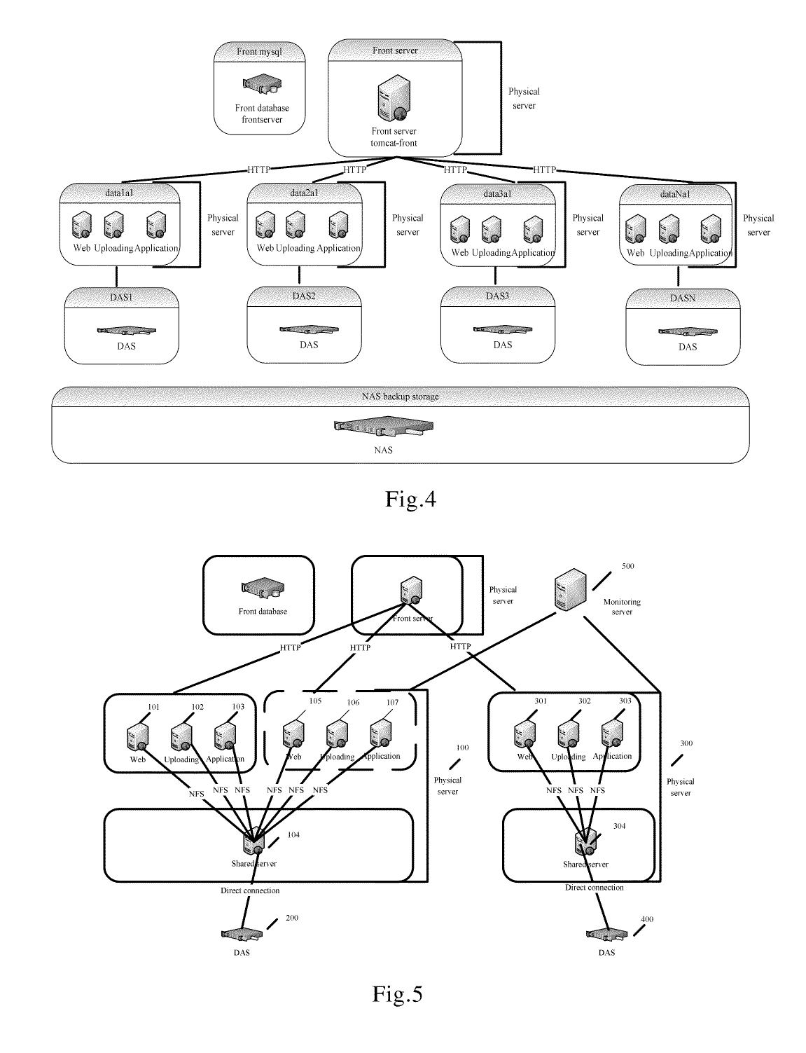

In one embodiment of the present invention, multiple sets of application service groups can be deployed in a single physical application server, to improve the system performance. FIG. 3 illustrates the structure diagram of a big data storage system provided in one embodiment of the present invention. As shown in FIG. 3, two application service groups are established in one physical server, wherein each application service group includes three application servers with different functions. As shown in FIG. 3, each application service group includes rear Web server vm1 or vm4 (corresponding to a front Web server, wherein the front Web server is usually located in another independent physical server for safety, as shown in FIG. 4), application server vm2 or vm5 (used to provide the user with different applications, such as mail server, file server, etc.), and uploading server vm3 or vm6 (used to receive and process uploading requests and data of the user). The physical server further includes a virtual machine vm7, which supports shared storage function. Multiple virtual machines can access a DAS device at the same time by using the virtual machine vm7. Virtual machines vm1-vm6 are connected with virtual machine vm7 through the internal bus of the physical server, and are directly connected with DAS through virtual machine vm7. In one embodiment of the present invention, virtual machines vm1-vm6 are connected with virtual machine vm7 through NFS protocol. In one embodiment of the present invention, application service group may also contain a database server, and each application service group may contain different types and numbers of virtual servers. For example, the first application service group may contain two application servers, and the second application service group may contain no application server or only one application server, but contain one database server. Furthermore, the number of virtual machines is not limited to the number shown in FIG. 2.

Those skilled in the art can understand that the types and number of application service groups on a single physical server are not limited to those shown in the figures. The number of application service groups can be increased or decreased according to the performance of physical servers and the requirement of actual applications.

FIG. 4 illustrates the structure diagram of a big data storage system provided in another embodiment of the present invention. As shown in FIG. 4, the big data storage system is a further expansion on the basis of the big data storage system shown in FIG. 2 and FIG. 3. Supposing the physical server 100 and direct-attached storage disk 200 shown in FIG. 2 form a storage subsystem, the big data storage system shown in FIG. 4 includes at least N subsystems (N is an integer greater than 1 or equal to 1, and usually is a large number in the case of big data storage). Each subsystem processes and stores data from different users, for example, data from different users are stored in different subsystems according to the user ID. In one embodiment, each subsystem can store data from 10000 users. Data from users with IDs of 0-9999 are stored in DAS1 of the first subsystem, and data from users with IDs of 10000-19999 are stored in DAS2 of the second subsystem, and so on.

The system shown in FIG. 4 further includes: a front server, adapted to receive a user request, guide the user request to corresponding subsystem for processing and storing the user request according to the corresponding relationship between each user and subsystem recorded in an index database; the index database, adapted to store the corresponding relationship between each user ID and subsystem (the corresponding relationship may be not the aforementioned sequenced relationship, for example, the user with ID of 1000 may be in the first subsystem, the user with ID of 1001 may be in the second subsystem, and the user with ID of 1002 may be in the first subsystem). In one embodiment of the present invention, the front database and index database may be in the same physical server.

The number of subsystem in the system may be rapidly expanded by simply adding the corresponding relationship between user IDs and subsystem to the index database. When subsequent users access the system, the front server serves as the unified user interface and guides the user request to the corresponding subsystem.

In one embodiment of the present invention, if user A shares one document with another user B, wherein data from user A are in the first subsystem, and the request from user B are processed by the second subsystem; when user B expects to access the shared document, the process includes following steps: the front server guides the request from user B into the physical server of the second subsystem; after finding the requested document is in the first subsystem, the physical server of the second subsystem asks the physical server of the first subsystem to provide the shared document; after receiving the request from the second subsystem, the physical server of the first subsystem firstly verifies the validity of the request (i.e., verify whether user B has the permission), then gets the shared document from DAS1 of the first subsystem, and returns the shared document to the physical server of the second subsystem.

The system further includes an NAS system as the backup of the DASs. Once the DASs are damaged, the virtual servers in the subsystems may directly get the backup data from the NAS to provide services to the user. Since the NAS is only used for backup, the requirement of NAS's performance is not high, which considerably reduces the cost. Moreover, although FIG. 4 only shows an NAS disk, multiple NAS disks may be used as the backup system in an embodiment.

In one embodiment of the present invention, the system further includes an offline backup server, adapted to backup data on NAS. The system security can be further guaranteed by using both NAS backup and offline backup.

Those skilled in the art can understand that the shared server virtual machine is shown in the each physical server in FIG. 4.

FIG. 5 illustrates the structure diagram of a big data storage system provided in another embodiment of the present invention. As shown in FIG. 5, physical servers 100 and 300 are directly connected with direct-attached storages 200 and 400, respectively, and the system also contains a monitoring server 500.

In normal situation, virtual machines 101-103 get data on the direct-attached storage 200 through a virtual machine 104, and represent the data on the direct-attached storage 200 to the user. Virtual machines 301-303 get data on a direct-attached storage 400, and represent the data on the direct-attached storage 400 to the user. Once the monitoring server 500 finds that physical server 300 stops working, the user request originally responded by the physical server 300 is guided to the physical server 100, and the virtual machines (virtual machines 101-103 or newly added virtual machines 105-107) in the physical server 100 presents data on the direct-attached storage 400 to the user. Similarly, once the monitoring server 500 finds that the physical server 100 stops working, the user request originally responded by the physical server 100 is guided into physical server 300, and the virtual machines in the physical server 300 presents the data on the direct-attached storage 200 to the user.

Specifically, when the monitoring server 500 finds the physical server 300 stops working, return this information to the front server and index database. The index database updates the corresponding relationship between each user ID and subsystem, and the front server transfers the user request that was originally to the physical server 300 to the physical server 100.

In another embodiment of the present invention, the direct-attached storage 200 stores the mirror image of the virtual machines 101-104 on the physical server 100. When physical server 100 stops working, the physical server 300 can invoke the mirror image of the virtual machines 101-104 on the direct-attached storage 200 to run new virtual machines to access data on the direct-attached storage 200.

In another embodiment of the present invention, the physical server 100 and/or 300 may built in SSD hard disk and memory as the buffer to further improve the performance.

Those skilled in the art can understand that the whole big data storage system may be extended by increasing the number of storage subsystems. For example, a big data storage system may contain 4000 storage subsystems, and each physical server may be connected with parts or all of direct-attached storages. In this case, once the monitoring system finds the physical server of one subsystem stops working, the user request responded by this physical server is then transferred to other physical servers connected with the direct-attached storage of the subsystem, and then the direct-attached storage of the subsystem can be accessed through the other physical servers.

Those skilled in the art can understand that the technical schemes described in embodiments of the present invention may be combined in various ways. The big data storage system obtained by the combination is also within the protection scope of the present invention. For example, each physical server shown in FIG. 4 only lists one application service group, however, the internal structure of each physical server may be the same with that shown in FIG. 2 or FIG. 3. Another example is that each subsystem of FIG. 4 may be divided into groups, wherein each group uses the technical scheme shown in FIG. 5 to guarantee the redundancy.

The system disclosed in embodiments of the present invention can avoid the single point of failure, and hence achieve a better security.

Embodiments of the present invention disclose a cloud storage method and device, to provide efficient storage of huge amounts of data.

A cloud storage method, disclosed in embodiments of the present invention, includes:

calculating the hash value of a file, converting the hash value of the file into the string, and using the string as the filename;

calculating the storage path of the file by using the hash value of the file according to a predefined rule;

looking up an physical storage location of the storage path of the file in an index table and storing the file in the physical storage location, wherein the index table stores corresponding relationship tables between all possible storage paths and physical locations in the storage disk in advance.

A cloud storage device, disclosed in embodiments of the present invention, includes:

a first module, adapted to calculate the hash value of a file according to a predefined hash algorithm;

a second module, adapted to convert the hash value of the file calculated by [symbol] the first module into the string and use the string as the filename;

a third module, adapted to calculate the storage path of the file according to the predefined algorithm by using the hash value of the file calculated by the first module;

a fourth module, adapted to store corresponding relationship tables between all possible storage paths and physical storage locations in the storage disk;

a fifth module, adapted to look up an physical storage location of the storage path of the file in the fourth module according to the storage path of the file calculated by the third module;

a sixth module, adapted to store the file in the physical storage found by the fifth module.

By using the cloud storage method and device provided in embodiments of the present invention to store huge amounts of data, since the file is stored via using the hash value, duplicate storage of mass data can be avoided. The storage path of the file is calculated according to the hash value, which guarantees that the data are evenly stored in storage servers to guarantee the balanced storage of the system. Even though the storage servers of the cloud storage system infinitely extend, the storage of the file can be managed efficiently with this method.

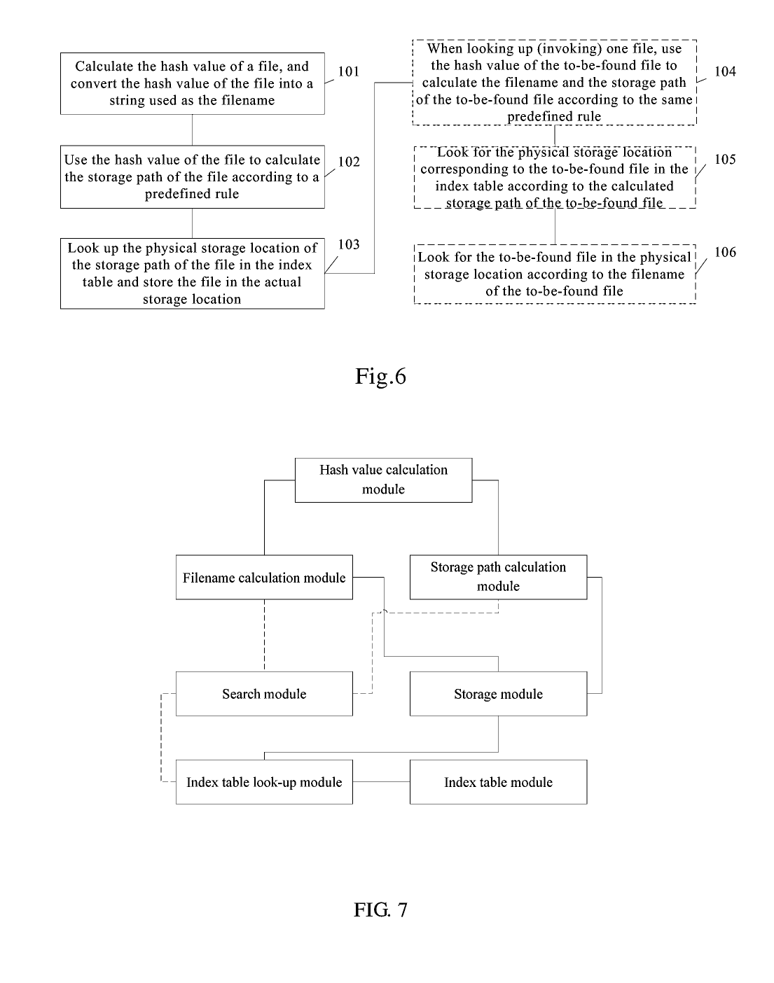

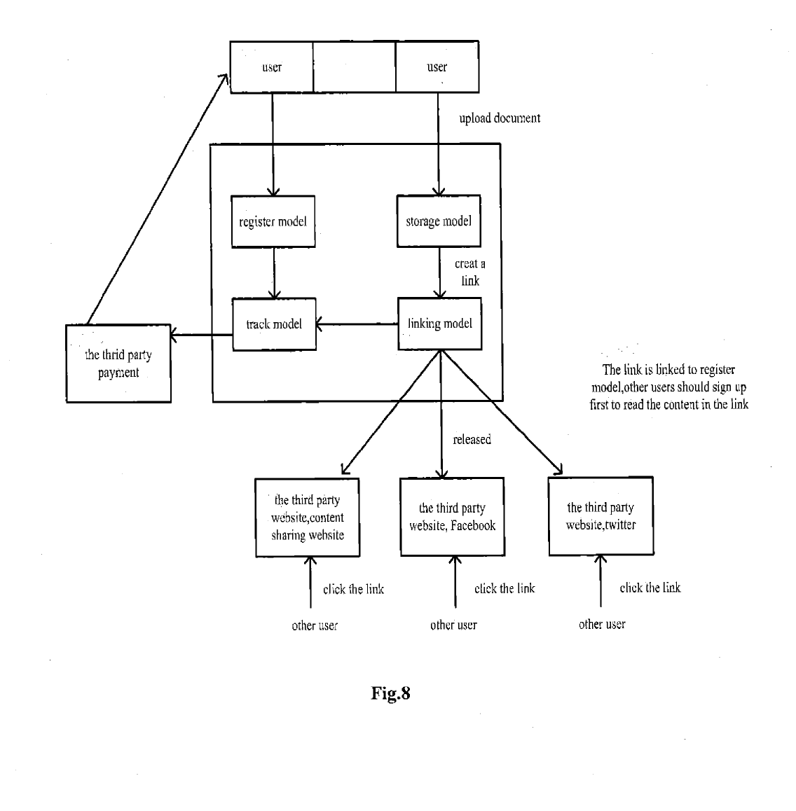

FIG. 6 illustrates the flowchart of the cloud storage method disclosed in embodiments of the present invention. As shown in FIG. 6, storing a file in the cloud includes following steps.

Step 101: Calculate the hash value of the file, and convert the hash value of the file into a string, and use the string as the filename.

Here, different hash algorithms, such as MD2, MD4, MD5 and SHA-1 algorithms, may be chosen according to the system configuration. In one embodiment of the present invention, the double hash algorithm may be used as the filename, i.e., calculating hash values of the files by using two different hash algorithms, and then connecting the two hash values as the hash value of the file.

In one embodiment of the present invention, the hash value of the file is converted into 36 hex string which is used as the filename. For example, the filename may H₁H₂H₃ . . . H_{N}.

Step 102: calculate the storage path of the file according to a predefined rule by using the hash value of the file.

In one embodiment of the present invention, the predefined rule may be: the storage path of the file consists of two levels of directories. For example, directly use the first and second letters/digits of the filename as the name of the first-level directory to store the file, and use the third and fourth letters/digits of the filename as the name of the second-level directory to store the file.

For example, in the embodiment, use H₁H₂ as the name of the first-level directory, and use H₃H₄ as the name of the second-level directory. Finally, the storage path of the file named H₁H₂H₃ . . . H_{N} is H₁H₂\H₃H₄.

When using the 36 hex string as the filename, the system may theoretically contain a maximum of 36²=1296 first-level directories and 36²*36²=1679616 second-level directories.

Usually, each subdirectory may manage at least 10000 files in a Linux system. Hence, using the double-digit 36 hex string and the two-level-directory storage method provided in the embodiments of the present invention, the system may theoretically storage and manage more than 10 billion files.

Step 103: Look up a physical storage location of the storage path of the file in an index table and store the file in the physical storage, wherein the index table has stored corresponding relationship tables between all possible storage paths and physical storage locations in the storage disk in advance.

Still taking the above as an example, the index table has recorded locations in the storage disk corresponding to 1679616 storage paths (two-level directories), i.e., the specific volume of the specific storage server which each two-level directory locates is recorded. Such the index table usually only costs a few megabytes space, and may be in the form of arrays, which can be directly obtained by the subscript. For example, the index table records that the path, whose first-level directory name is AB and second-level directory name is CD, is stored in the third logical volumes of the first disk.

The file is stored in the storage disk recorded in the index table and corresponding to the file's storage path.

Step 104: When looking up (invoking) one file, calculate the filename and the storage path of the to-be-found file according to the same predefined rule by using the hash value of the to-be-found file;

For example, in one embodiment of the present invention, first four letters/digits of the filename is extracted, and the first-level storage directory and the second-level storage directory are obtained.

Step 105: Looking for the identification (or name) of the physical storage location (physical disk) recorded in the index table and corresponding to the to-be-found file according to the calculated storage path of the to-be-found file.

Step 106: looking for the file in the physical disk of the to-be-found file according to the filename of the to-be-found file.

The reason for recording the physical storage locations of all possible storage paths in the index table in advance is to speed up the storage and search.

The physical storage may include a storage server, when extending storage servers of the cloud storage system, move parts of directories in existing storage servers to an extended storage server, and update records in the index table at the same time.

In the actual operation process, the storage server usually carries multiple storage disks. When adding a storage disk to the current storage server, copy parts of directories in the existing storage disk to the newly added storage disk. When adding a new storage server, directly plug parts of storage disks in the existing storage server into the newly added storage server. Although the existing storage server still needs new storage disk, and needs copying the content from the rest of storage disks in the storage server to the new storage disk, the speed of copying data within the same storage server is much faster than that of copying data between different storage servers.

The storage method disclosed in embodiments of the present invention can be used for the storage of mass data. Using this method to store huge amounts of data can avoid the duplicate storage of mass data, since the file is stored via using the hash value. Moreover, when the data volume is large enough, calculating the storage path of the file according to the hash value can guarantee that the data are evenly stored in storage servers to guarantee the balanced storage of the system. Even though the storage servers of the cloud storage system infinitely extend, the storage of the file can be managed efficiently with this method. Furthermore, the index table may be stored in the Web server such that a file can be quickly found from huge amounts of servers when the user needs to look up the file.

In another embodiment of the present invention, the system parameters can be adjusted according to the storage level required to be supported by the system. For example, the hash value of the file may be converted into the decimal value. In this case, if other parameters of the last embodiment remain unchanged, the system may theoretically support 102*102=104 second-level directories. It is also feasible to use the first letter/digit of the hash value as the filename of the first-level directory, and use the second, third, and fourth letters/digits as the filename of the second-level directory. In this case, if other parameters of the last embodiment remain unchanged, the system may still support 36*363=1679616 second-level directories theoretically. It is also feasible to use the three-level storage, for example, use the first letter/digit of the hash value as the filename of the first-level directory, use the second and third letters/digits as the filename of the second-level directory, and use the fourth letter/digit as the filename of the third-level directory. In conclusion, those skilled in the art can configure system parameters according to system requirements.

FIG. 7 illustrates the structure diagram of the cloud storage device disclosed in embodiments of the present invention. As shown in FIG. 7, the cloud storage device runs on the device containing a processor and a storage module. The device includes:

a hash value calculation module, adapted to calculate the hash value of a file according to a predefined hash algorithm;

a filename calculation module, adapted to convert the hash value of the file calculated by the hash value calculation module into the string and use the string as the filename;

a storage path calculation module, adapted to calculate the storage path of the file according to the predefined algorithm by using the hash value of the file calculated by hash value calculation module;

an index table module, adapted to store corresponding relationship tables between all possible storage paths and physical storage locations in the storage disk;

an index table look-up module, adapted to look up the name of the physical storage location of the storage path of the file in the index table module according to the storage path of the file calculated by the storage path calculation module, when invocated by a storage module;

the storage module, adapted to invoke the index table look-up module and store the file in the storage disk returned by the index table look-up module.

When looking up (invoking) one file, use the hash value calculation module to calculate the hash value of the to-be-found file, use the filename calculation module to calculate the filename of the to-be-found file, use the storage path calculation module to calculate the storage path of the to-be-found file, and use the index table look-up module to find the physical disk corresponding to the to-be-found file in the index table module according to the storage path of the to-be-found file calculated by the storage path calculation module. In this case, the cloud storage device further includes:

a search module, used to invoke the index table look-up module according to the storage path of the to-be-found file calculated by the storage path calculation module, and search for the to-be-found file in the physical disk according to the filename of the to-be-found file calculated by the filename calculation module.

An embodiment of the present invention, a cloud document service is provided.

The cloud document service includes following steps.

### Registering

User accesses the registration page and creates a regular Service account, by which the user that needs to register as an affiliate.

User may also access the affiliate registration page and create an affiliate Service account.

### Setting Up

If user signs up for a regular Service account, they must locate the “Affiliate Program” portion of the website (or whichever name is designated as the proper affiliate program), agreed to the terms of service and join the program.

If user has already signed up for the affiliate program through the affiliate registration page, then no further steps are required for the account to be set up.

### Storage

User uploads document to Service that can be stored or shared.

The user may upload documents and files directly into the system, through an API, or through a link provided by another user, or any other method available to the user.

### Conversion of Stored Content

After content is uploaded into Service, The Service will convert the content into a new web friendly format such as HTML 5 or other formats.

The newly generated document will have a layout similar to the original document.

### Linking

The Service creates a link for every document or folder the user uploaded.

The link is system generated, but may also be determined by the user.

### Sharing

### User Shares the Link(s)

Sharing the link can occur through embedding, URL redirect, pasting, messaging, email attachment, or any other form of distribution whether on third party websites/services, social media sites, or any other content sharing medium.

### New User Origination

Other users who click the link will be required to register at a specific point in time which is predetermined. Registration may be required immediately after the click of a link, after viewing a certain number of pages of a document, before downloading the document, or at any other predetermined point of user interaction.

After registering, the new users will be able to read the document of that link.

### New User Tracking

Every registered user that was originated from that document link is tracked by the Service.

This information may include the total number of users, timestamp of registration, IP address of user, or any other user related data.

### Calculation

Depending on the terms of service or the specific agreement reached with the affiliate, the Service will perform the calculation to determine the specific amount of payment due to the affiliate.

Payment calculation may be based on total number of users, total number of users in a given time period, types of users, post user sign-up activity, or any other variable or user related data.

Once calculation is made, the Service will pay the affiliate accordingly.

### Payment Process

Payment distribution may be made according to different schedules depending on the agreement with the affiliate.

For example, payment may be made once per month with a minimum threshold for payment, or according to the agreement reached by the Service and affiliate.

### Payment Method

The payment function can be implemented by the Service's internal systems or a third party payment service, integration company, etc.

One implementation is that the Service will automatically generate the payment information which will then be uploaded, shared, or submitted to the proper payment system (PayPal, wiring solutions, check distribution solutions, bank solutions, Service internal system, etc.) who will submit payment to the affiliate.

### Activity History and Recording

The Service may release (according to terms of service or separate agreement), embed, share a link, or distribute the statistics on user registration in any way shape or fashion.

This information may include any and all user related data and information, including but not limited to names, e-mail addresses, and other revenue generated from user, or any other statistic related to the user.

A non-transitory computer-readable storage medium is provided in an embodiment of the present invention, having one or more computer-readable instructions when read, cause one or more processors on a client device to execute steps disclosed in the above embodiments.

The above content only includes preferred embodiments of the present invention, and is not used to limit the present invention. Any modification, replacement, and improvement made within the spirit and principle of the present invention will be considered to be within the protection scope of the present invention.

1. A cloud storage method, comprising:
calculating the hash value of a file, converting the hash value of the file into the string, and using the string as the filename;
calculating the storage path of the file by using the hash value of the file according to a predefined rule;
looking up a physical storage location of the storage path of the file in an index table and storing the file in the physical storage location, wherein the index table stores corresponding relationship tables between all possible storage paths and physical storage locations in the storage disk in advance.

2. The method of claim 1, wherein when looking up a file, the method further comprises:
calculating the filename and the storage path of the to-be-found file according to the same predefined rule by using the hash value of the file;
looking for the identification of the physical storage location of the to-be-found file, recorded in the index table, according to the calculated storage path of the to-be-found file;
looking for the to-be-found file in the physical storage location corresponding to the storage path of the to-be-found file according to the filename of the to-be-found file.

3. The method of claim 1, wherein converting the hash value of the file into a string comprises:
converting the hash value of the file into the decimal or 36 hex string.

4. The method of claim 1, wherein the predefined rule comprises: the storage path of the file consisting of two levels of directories.

5. The method of claim 4, wherein the storage path of the file consisting of two levels of directories comprises:
directly using the first and second characters of the filename as the name of the first-level directory to store the file, and using the third and fourth characters of the filename as the name of the second-level directory to store the file.

6. The method of claim 4, wherein, the physical storage comprises a storage disk, when adding another storage disk to the physical storage, the method further comprises:
copying parts of directories in the existing physical storage to the newly added storage disk;
updating the records in the index table at the same time.

7. The method of claim 4, wherein, the physical storage comprises a storage server and the storage server comprises storage disks; when adding a new storage server to the physical storage, the method further comprises:
plugging parts of storage disks in the existing storage server into the newly added storage server;
updating the records in the index table at the same time.

8. A non-transitory computer-readable storage medium, having one or more computer-readable instructions when read, cause one or more processors on a client device to execute steps comprising:
calculating the hash value of a file, converting the hash value of the file into the string, and using the string as the filename;
calculating the storage path of the file by using the hash value of the file according to a predefined rule;
looking up a physical storage location of the storage path of the file in an index table and storing the file in the physical storage location, wherein the index table stores corresponding relationship tables between all possible storage paths and physical locations in the storage disk in advance.

9. The non-transitory computer-readable storage medium of claim 6, wherein, one or more computer-readable instructions when read, cause one or more processors on a client device to execute steps further comprising:
when looking up a file,
calculating the filename and the storage path of the to-be-found file according to the same predefined rule by using the hash value of the file;
looking for the identification of the physical storage location of the to-be-found file, recorded in the index table, according to the calculated storage path of the to-be-found file;
looking for the to-be-found file in the physical storage location corresponding to the storage path of the to-be-found file according to the filename of the to-be-found file.
